(19) United States
(12) Patent Application Publication
(10) Pub. No.: US 2023/0241604 A1
(43) Pub. Date: Aug. 3, 2023

(54) Methods and Devices for Measuring Particle Properties

(71) Applicant: TDK Corporation, Tokyo (JP)

(72) Inventors: Manish Giri, San Jose, CA (US); Rakesh Sethi, San Jose, CA (US); Vadim Piskun, San Jose, CA (US)

(73) Assignee: TDK Corporation, Tokyo (JP)

(21) Appl. No.: 17/589,598

(22) Filed: Jan. 31, 2022

(51) Int. Cl. B01L 3/00

(52) U.S. Cl. CPC B01L 3/502715; B01L 3/502761; B01L 2300/0663; B01L 2300/0645; B01L 2400/0436

(57) ABSTRACT

Various embodiments described herein include methods and devices for the evaluation of sub-cellular and molecular structures of cells and particles. In one aspect, a microfluidic device includes: (i) a sensor positioned adjacent to a microfluidic channel for detecting particles flowing through the microfluidic channel and (ii) a transmission line positioned adjacent to the sensor for receiving electromagnetic signals from the sensor.

### TECHNICAL FIELD

This application relates generally to electrical measurements, and more particularly to methods and devices for performing electrical measurements of particle properties, such as cellular properties.

### BACKGROUND

Knowledge of cellular properties is an important tool in the life sciences industry. It allows for classification of cells as well as detection, identification, and quantification of diseases. Thus, quick and accurate detection of cellular properties is highly desirable.

### SUMMARY

Exploration of cellular properties, including sub-cellular and molecular properties, is increasingly important for life sciences research as well as diagnostic applications (e.g., rapid point-of-care diagnostic applications). The devices and methods described herein address challenges associated with conventional devices and methods for measuring cellular properties. First, conventional systems have used relatively low frequencies to investigate cellular properties. These low frequencies cannot accurately detect sub-cellular and molecular properties. Second, conventional systems that rely on impedance sensing have limitations in terms of a direct correlation to a dielectric constant, the rate of analysis, and the sensitivity of measurement. Third, conventional systems with large electrodes compared to the size of the cell can lead to overlap of cells, which makes the analysis of individual cells challenging.

The present disclosure describes methods and devices for probing the cells in a gigahertz (GHz) frequency domain, e.g., to elicit a response from the cytoplasm, the vacuoles, and the nucleus of the cells. The present disclosure further describes an electrode architecture with an overlaid microfluidic channel at a high sensitivity resonant zone of a sensing cavity. With this architecture, when a cell passes through the resonant zone, the resonance shifts based on dielectric properties of the cell. The resultant shift in the properties corresponds to a “Maxwell Mixture” ratio of the cell and the surrounding fluid. Once the cellular properties are identified, the electrical properties of the cytoplasm and sub-cellular components can be determined. Thus, this architecture addresses the challenge of rapid label-free sensing and phenotyping of single cells utilizing high frequency responses (e.g., above the MHz frequency domain), which may not be feasible with conventional systems or methods, such as surface functionalized antibody labelling.

In accordance with some embodiments, a microfluidic device includes: (i) a substrate with a microfluidic channel; (ii) a sensor positioned adjacent to the microfluidic channel for detecting particles flowing through the microfluidic channel; and (iii) a transmission line positioned adjacent to the sensor for receiving electromagnetic signals from the sensor.

In accordance with some embodiments, a method includes: (i) providing a plurality of particles through a microfluidic channel; (ii) detecting the plurality of particles flowing through the microfluidic channel with a sensor positioned adjacent to the microfluidic channel; and (iii) transmitting electrical signals with a transmission line positioned adjacent to the sensor.

Thus, methods and devices for determining cellular properties are disclosed. Such methods and devices may complement or replace conventional methods and devices for determining cellular properties.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a graph illustrating an impedance of a cell as a function of frequency in some circumstances.

FIG. 2 is a graph illustrating an example frequency shift due to dielectric properties of a particle in accordance with some embodiments.

FIG. 3 illustrates an example device in accordance with some embodiments.

FIG. 4A illustrates an example detection zone of the example device of FIG. 3 in accordance with some embodiments.

FIG. 4B illustrates an example fluidic channel positioned within the example detection zone of FIG. 4A in accordance with some embodiments.

FIG. 4C illustrates another example fluidic channel positioned within the example detection zone of FIG. 4A in accordance with some embodiments.

FIG. 4D illustrates another example fluidic channel positioned within the example detection zone of FIG. 4A in accordance with some embodiments.

FIG. 5 is a cross-sectional view of the example detection zone of FIG. 4B in accordance with some embodiments.

FIG. 6 illustrates an example electrode architecture using the example device of FIG. 3 in accordance with some embodiments.

FIG. 7 is a flow diagram illustrating a method of detecting particles in accordance with some embodiments.

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

### DESCRIPTION OF EMBODIMENTS

In some conventional cellular detection devices, the electrodes are constructed to be co-planar or in the top-down configuration with an electric field created between a sense electrode and a ground electrode. The present disclosure describes a device having a fluidic channel (e.g., a microfluidic channel) positioned adjacent to (e.g., placed over) a high sensitivity region of a ring electrode. In this way, an “electrical” resonance cavity is generated and the “resonance shift” is measured as a cell or other (e.g., dielectric) particle passes through the high sensitivity region. Advantages of such a device are described in detail below.

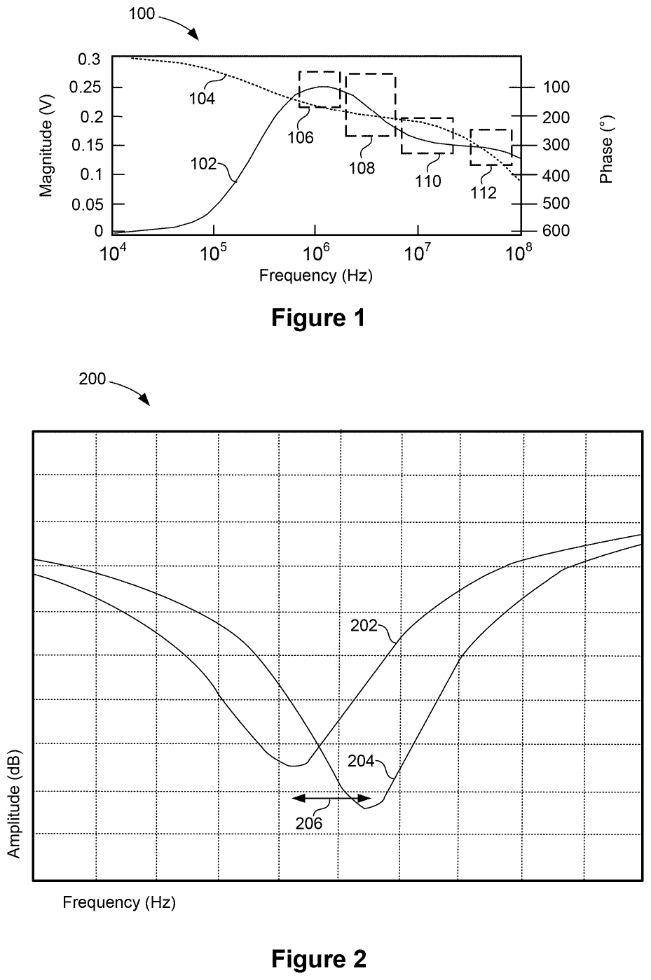

FIG. 1 shows a graph 100 illustrating an impedance of a cell as a function of frequency. In FIG. 1, a signal 102 indicates changes in magnitude (V) as a function of frequency and a signal 104 indicates changes in phase (in degrees) as a function of frequency. FIG. 1 further shows detection zones 106, 108, 110, and 112. The detection zone 106 occurring around a frequency magnitude of 10⁶ provides information indicating cellular size. The detection zone 108 provides information indicating a structure of a cellular membrane. The detection zone 110 occurring around a frequency magnitude of 10⁷ provides information indicating a structure of cytoplasm. The detection zone 112 provides information indicating a structure of vacuoles. In accordance with some embodiments, frequencies greater than 100 megahertz are utilized to analyze intrinsic electrical signatures from sub-cellular and molecular materials. In accordance with some embodiments, the GHz frequency domain is most sensitive to sub-cellular composition of a cell and is usable as an early marker for any cell abnormalities as well as the early origins of infections.

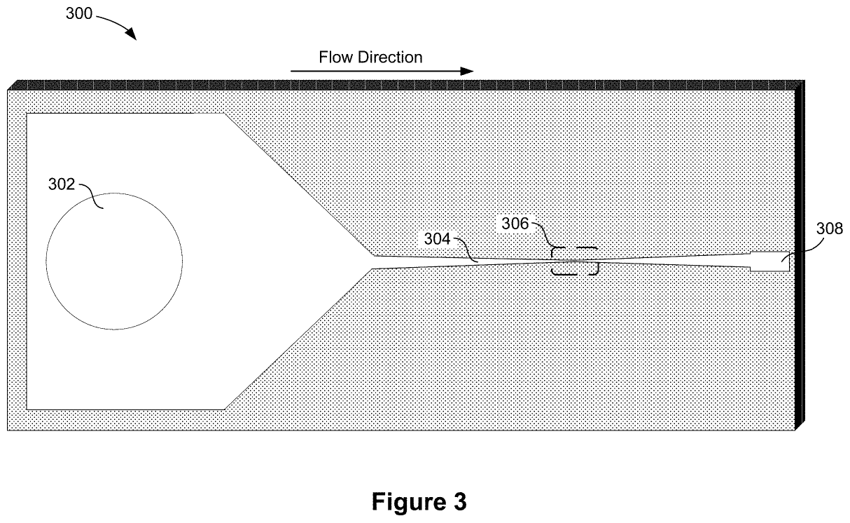

FIG. 2 shows a graph 200 illustrating a frequency shift 206 (e.g., a resonance shift) due to dielectric properties of a particle (e.g., a cell) in accordance with some embodiments. In FIG. 2, the signal 202 corresponds to a resonance curve without the presence of the particle and the signal 204 corresponds to a resonance curve with the presence of the particle. In addition to the frequency shift 206, the amplitude peak and sharpness of signal 204 have also changed with respect to signal 202 due to the presence of the particle. The frequency shift 206 in FIG. 2, as well as the changes in amplitude peak and sharpness, correspond to properties of the particle (e.g., dielectric properties). Thus, at least one of the frequency shift 206, the change in amplitude peak, or the change in the sharpness may be used to determine the presence of the particle. In some embodiments, a combination of the frequency shift 206, the change in amplitude peak, and the change in the sharpness are used to determine the presence of the particle. Similarly, in some embodiments, at least one of the frequency shift 206, the change in amplitude peak, or the change in the sharpness is used to determine the electrical properties of the particle. In accordance with some embodiments, the frequency range in FIG. 2 is in gigahertz (GHz), for example, ranging from 4 GHz to 5 GHz. In accordance with some embodiments, operating in a gigahertz frequency range allows for probing within the cell membrane and into the nucleus.

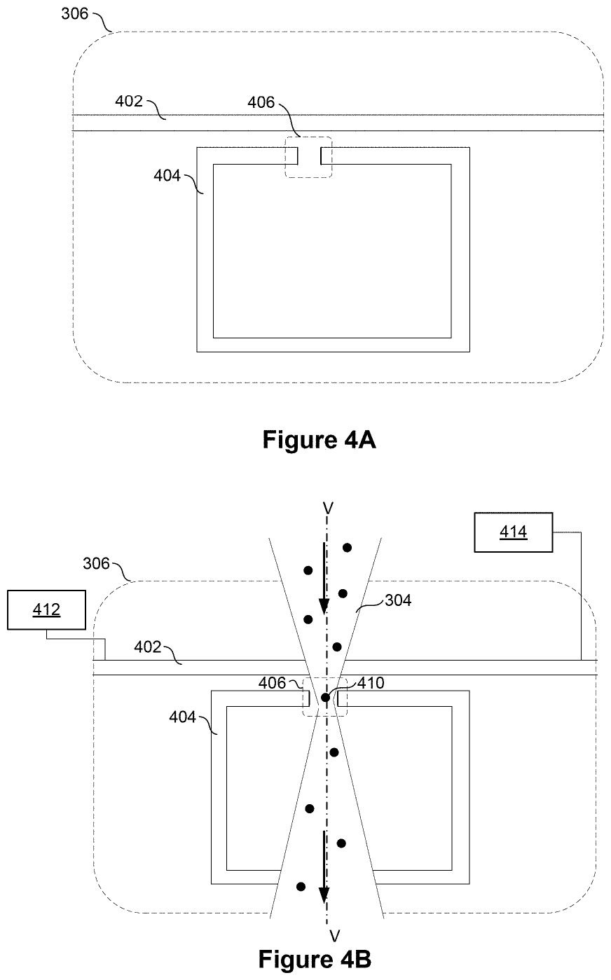

FIG. 3 illustrates a device 300 in accordance with some embodiments. The device 300 includes an input location 302 for introducing the fluid with particles (e.g., cells), a fluid channel 304 (e.g., a microfluidic channel) with a detection zone 306, and a connection location 308 for sample ejections or delivery. In some embodiments, the input location 302 includes an inlet port. In some embodiments, the input location 302 includes a piezoelectric actuator for sample input mixing. In some embodiments, the connection location 308 includes an outlet nozzle. In some embodiments, the connection location 308 is configured for use with a piezoelectric ejector. In some embodiments, the connection location 308 is configured for use with a micro-electro-mechanical system (MEMS) ejector. In some embodiments, the detection zone 306 includes a narrowing of the fluid channel 304, e.g., on the order of the size of the particle to be analyzed. For example, for cellular measurements, the fluid channel 304 narrows at the detection zone 306 to be on the order of the size of the cell such that only a single cell is detected at a time. In some embodiments, the width of the fluid channel 304 at the detection zone 306 is in the range of 10 microns to 100 microns.

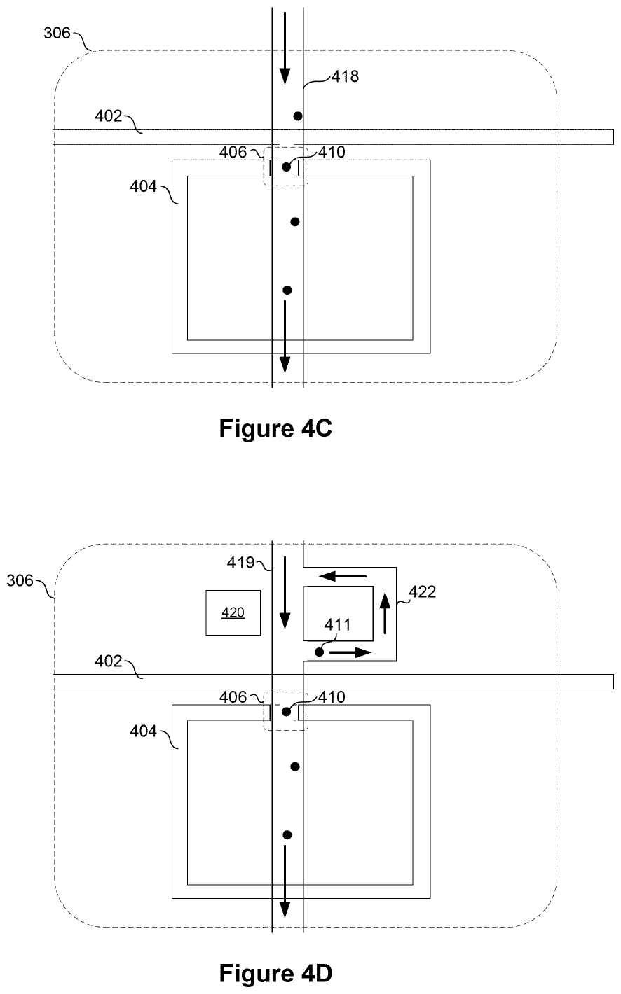

FIG. 4A illustrates the detection zone 306 of the device 300 in accordance with some embodiments. The detection zone 306 includes a transmission line 402 and a ring electrode 404. The region 406 is a region of high sensitivity for the ring electrode 404 (e.g., the region 406 is a region of highest sensitivity for the ring electrode). In some embodiments, the region 406 corresponds to a discontinuity in the ring electrode 404 (e.g., the ring electrode 404 has a gap, which corresponds to the region 406). Although FIG. 4A shows the ring electrode 404 as having a rectangular shape, in some embodiments, the ring electrode 404 has a circular or elliptical shape. In some embodiments, the ring electrode 404 has rounded or clipped corners. In some embodiments, the region 406 is between two ends of the ring electrode 404. In some embodiments, the ring electrode 404 forms a resonance cavity, where the transmission line 402 measures changes in the resonance cavity. In some embodiments, the ring electrode 404 has a thickness less than 10 microns, e.g., in a range of 2-5 microns. In some embodiments, the ring electrode 404 has a width less than 2000 microns, e.g., in a range of 50-1000 microns. In some embodiments, the spacing between the transmission line 402 and the ring electrode 404 is less than 200 microns, e.g., in the range of 10-100 microns.

The ring electrode 404 in FIG. 4A is an example of a resonator in some configurations. In some embodiments, the ring electrode 404 is replaced with a strip-line resonator. In some embodiments, the ring electrode 404 is replaced with a closed cavity resonator. In some embodiments, the ring electrode 404 is replaced with a parallel plate resonator, e.g., using electrodes as a capacitor. In some embodiments, the parallel plate resonator is connected to an inductor. In some embodiments, the ring electrode 404 is replaced with any suitable type of resonator. In some embodiments, the transmission line 402 comprises a waveguide, a microstrip, or a stripline. In some embodiments, the transmission line 402 and the resonator are coupled via edge coupling, iris coupling, loop coupling, stud coupling, or proximity (e.g., inductive) coupling.

FIG. 4B illustrates the fluid channel 304 positioned within the detection zone 306 in accordance with some embodiments. As shown in FIG. 4B, a convergent portion of the fluid channel 304 is overlaid with the high sensitivity region 406. In some circumstances, positioning the fluidic channel 304 in close proximity to the high sensitivity region 406 improves the signal-to-noise ratio (SNR) of the device 300. In some embodiments, the convergent portion has a width on the order of the size of the particles to be analyzed (e.g., such that a single cell 410 is analyzed at a time), such as between 1 micron and 200 microns. In some embodiments, the convergent portion of the fluid channel 304 is sized to allow small clusters of particles in the high sensitivity region 406 at a time (e.g., less than 100, 50, or 10 of the particles to be analyzed). In some embodiments, the resonance cavity and the fluidic channel are configured to analyze molecules (e.g., DNA). Although FIG. 4B shows the sides of the fluidic channel 304 as narrowing and widening linearly, in some embodiments, the sides are curved (e.g., and narrow exponentially). In some embodiments, the sides of the fluidic channel 304 narrow linearly to the convergent portion, but expand in a non-linear manner. In some embodiments, the sides of the fluidic channel 304 narrow in a non-linear manner to the convergent portion, but expand linearly. In some embodiments, the width of the convergent portion is less than 200 microns, e.g., between 1-100 microns. In some embodiments, the length of the convergent portion is less than 200 microns, e.g., between 1-100 microns. In some embodiments, the thickness of the convergent portion is less than 200 microns, e.g., between 1-100 microns. In some embodiments, the device includes driver circuitry 412 electrically coupled to the transmission line 402 and/or the ring electrode 404. In some embodiments, the driver circuitry is configured to produce electrical signals in the megahertz and gigahertz frequency domains. In some embodiments, readout circuitry 414 is electrically coupled to the transmission line 402 (e.g., at an opposite end from the driver circuitry 412). In some embodiments, the readout circuitry 414 is configured to measure resonance shifts (e.g., as shown in FIG. 2 and described above).

FIG. 4C illustrates a fluidic channel 418 positioned within the detection zone 306 in accordance with some embodiments. The fluidic channel 418 is similar to the fluidic channel 304 except that the fluidic channel 418 has a substantially uniform width (e.g., the width varies less than 20%, 15%, 10%, 9%, 8%, 7%, 6%, 5%, 4%, 3%, 2%, or 1%) adjacent to the high sensitivity region 406 (e.g., at least 1 mm, 0.5 mm, 0.4 mm, 0.3 mm, 0.2 mm, 0.1 mm, 90 microns, 80 microns, 70 microns, 60 microns, or 50 microns, within the high sensitivity region 406). In some embodiments, the fluidic channel 418 has a uniform width along the entire length of the fluidic channel 418.

FIG. 4D illustrates a fluidic channel 419 positioned within the detection zone 306 in accordance with some embodiments. The fluid channel 419 includes a bypass duct 422. In accordance with some embodiments, the bypass duct 422 comprises a delay loop configured to reduce flow speed (or increase the travel distance and the travel time) of particles in the fluidic channel 419 through the (high sensitivity) region 406. In accordance with some embodiments, the particles within the fluid in the fluidic channel are selectively redirected into the bypass duct 422, e.g., to selectively reduce flow speed (or increase the travel distance and the travel time) of the particles through the region 406. In some embodiments, a deflector 420 is activatable to redirect the particles into the bypass duct 422. In some embodiments, the deflector 420 is a piezoelectric deflector. In some embodiments, the deflector 420 is coupled to control circuitry (e.g., the control circuitry 412) and the control circuitry is configured to selectively enable and disable the deflector 420 (e.g., to redirect (deflect) particles into the bypass duct 422).

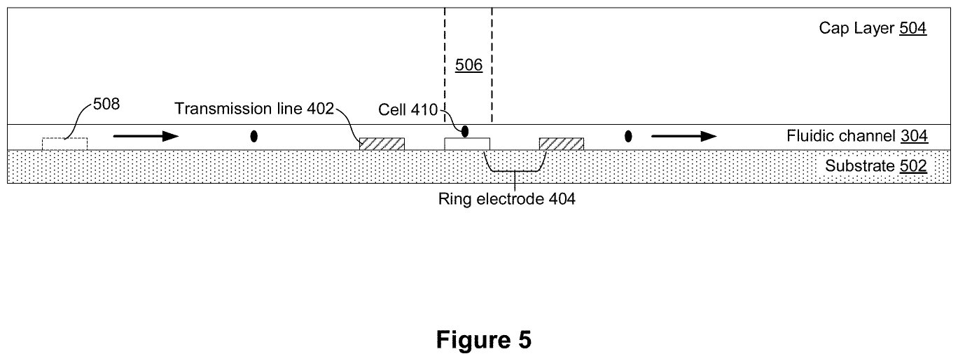

FIG. 5 is a cross-sectional view of the detection zone 306 in accordance with some embodiments. FIG. 5 shows the fluidic channel 304 on a same plane as the transmission line 402 and the ring electrode 404. FIG. 5 also shows the cell 410 in the convergent zone over the ring electrode 404 (e.g., over a gap defined by the ring electrode 404). In some embodiments, the fluidic channel 304 is positioned so that the cells pass under the ring electrode 404, rather than over it. As shown in FIG. 5, the fluidic channel 304 is between a substrate 502 and a cap layer 504. In some embodiments, the substrate 502 is composed of, or includes, silicon and/or glass. In some embodiments, the cap layer 504 is composed of, or includes, polymer (e.g., polydimethylsiloxane), silicon, and/or glass. In some embodiments, the fluidic channel 304 has a thickness (height) less than 200 microns (e.g., a thickness of 100, 90, 80, 70, 60, 50, 40, 30, 20, 10, or 5 microns). In some embodiments, the cap layer 504 includes an opening 506 adjacent to the ring electrode 404 to allow access to cells for aspirating and dispensing for next analysis.

In some embodiments, the transmission line 402 and/or the ring electrode 404 are utilized for radio frequency (RF) heating. In some embodiments, the RF heating is used simultaneously with cell analysis. For example, the RF heating is used for cell lysis and analysis is performed on the cell's DNA or RNA after the lysis. In some embodiments, one or more additional electrodes 508, separate from the transmission line 402 and/or the ring electrode 404, are placed within the microfluidic channel for the RF heating.

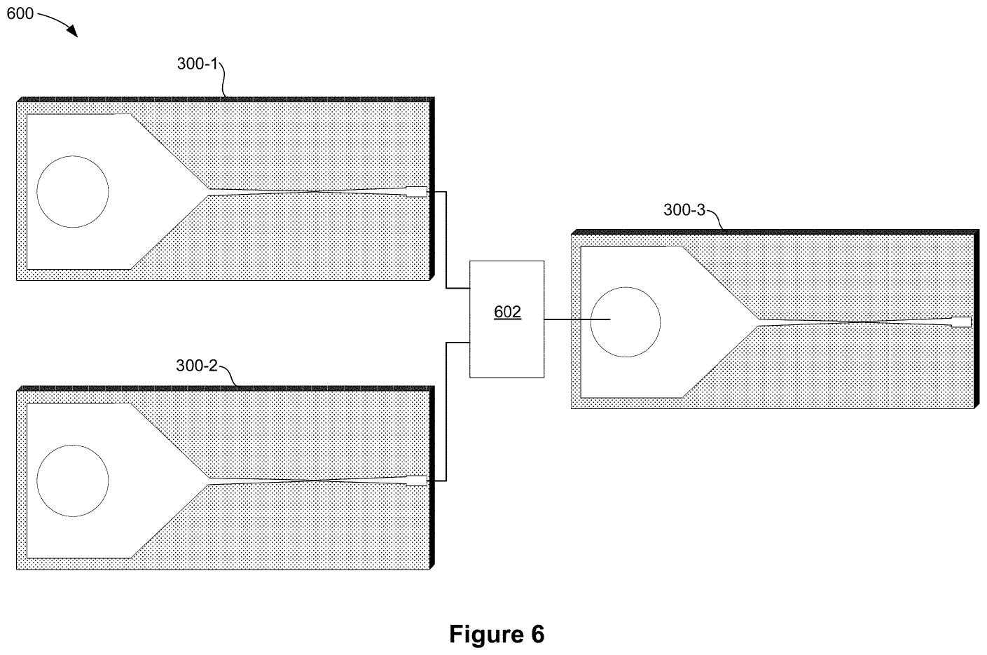

FIG. 6 illustrates an electrode architecture 600 utilizing a plurality of devices 300 in accordance with some embodiments. FIG. 6 shows two devices 300-1 and 300-2 arranged in parallel so as to allow for simultaneous analysis of multiple particles or cells. FIG. 6 further shows a third device 300-3 connected to the devices 300-1 and 300-2 via a multiplexer 602 (e.g., a fluidic switching device). In accordance with some embodiments, an array of devices 300 is multiplexed together to allow for stages of analysis. For example, the devices 300-1 and 300-2 are configured to identify cell types, e.g., by being driven at a resonance frequency corresponding to detection of cell size. In this example, if device 300-1 detects the desired type of cell, the cell can be routed through the multiplexer 602 to the device 300-3 for further analysis (e.g., sub-cellular analysis).

In some embodiments, the array of devices 300 is arranged in a parallel configuration and are used to perform different analysis on cells from a same sample. In some embodiments, the array of devices 300 is arranged in a serial configuration and are used to perform different analysis on cells from a same sample. For example, a first device 300 is driven at a first frequency range to detect cell membrane characteristics and a second device 300 is driven at a second frequency range to detect cell vacuole characteristics. In some embodiments, the devices 300 are operated simultaneously, while in other embodiments, at least a subset of the devices are operated sequentially, e.g., a second device is driven differently depending on the results from a first device.

In some circumstances, the device 300 has an advantage over conventional detection devices in that the high sensitivity resonance cavity is capable of measuring small shifts in the dielectric properties of cells, particles, and/or molecules in the fluidic channel above the cavity. In some circumstances, the device 300 has another advantage over conventional detection devices in that it is operable in the gigahertz frequency domain, which is capable of probing inside a cell membrane to analyze sub-cellular and molecular characteristics of a cell. In some circumstances, the device 300 has another advantage over conventional detection devices in that its design is scalable and can analyze both cells and molecules (e.g., DNA) as they flow passed the high sensitivity region (e.g., by adjusting a driving frequency of the device). In some circumstances, the device 300 has another advantage over conventional detection devices in that its design allows for RF heating as well as particle analysis (e.g., simultaneously).

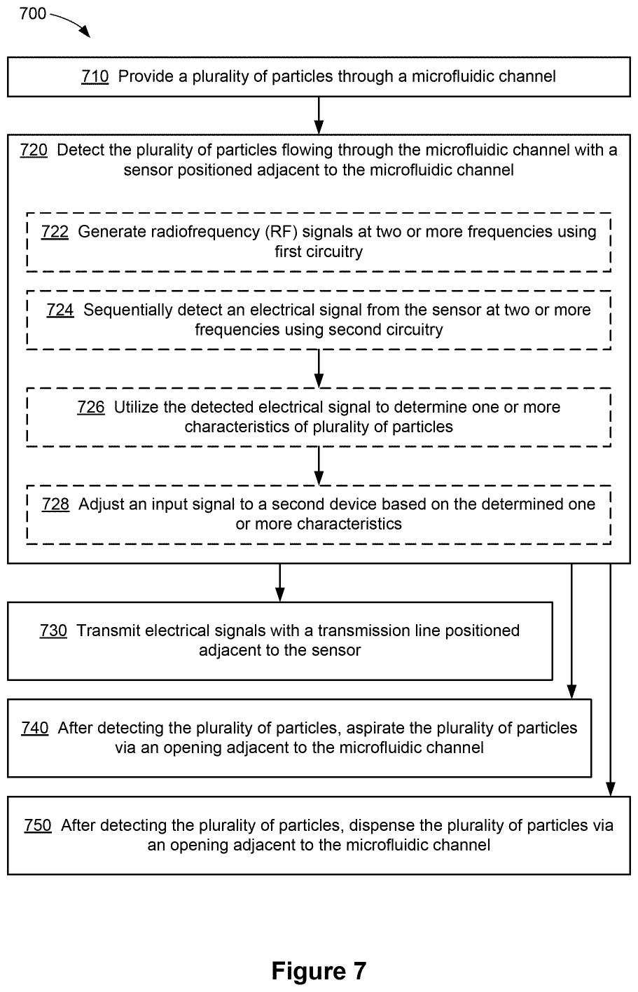

FIG. 7 is a flow diagram illustrating a method 700 of detecting particles in accordance with some embodiments. In some embodiments, the method is used for measuring particle characteristics, such as cellular and sub-cellular characteristics. In some embodiments, the method is performed at a device (e.g., the device 300).

(A1) In some embodiments, the method 700 includes: (i) providing (710) a plurality of particles (e.g., cell 410) through a microfluidic channel (e.g., the fluidic channel 304); (ii) detecting (720) the plurality of particles flowing through the microfluidic channel with a sensor (e.g., the ring electrode 404) positioned adjacent to the microfluidic channel; and (iii) transmitting (730) electrical signals with a transmission line (e.g., the transmission line 402) positioned adjacent to the sensor. In some embodiments, the transmission line comprises a transmission electrode. In some embodiments, the plurality of particles is provided via an inlet port, e.g., at input location 302. In some embodiments, detecting the plurality of particles comprises sequentially detecting each particle of the plurality of particles.

(A2) In some embodiments of A1, detecting the plurality of particles includes using a substantially enclosed loop sensor electrode (e.g., the ring electrode 404) with a gap (e.g., the gap at the high sensitivity region 406). In some embodiments, detecting the plurality of particles includes using a resonator (e.g., a closed cavity resonator, a strip-line resonator, a parallel plate resonator, or an optical ring resonator).

(A3) In some embodiments of A2, the plurality of particles is detected while passing the gap positioned adjacent to the microfluidic channel, e.g., while passing through the convergent portion of the fluidic channel 304 adjacent to the high sensitivity region 406 as shown in FIG. 4B. In some embodiments, each particle of the plurality of particles is detected as it passes over the gap.

(A4) In some embodiments of A1-A3, the sensor electrode substantially has a shape of a rectangle with a gap (e.g., as shown in FIG. 4A). In some embodiments, the sensor electrode has a shape of an oval, or circle, with a gap.

(A5) In some embodiments of A1-A4, the transmission line is substantially perpendicular to the microfluidic channel (e.g., as shown in FIG. 4B).

(A6) In some embodiments of A1-A5, at least a portion of the sensor adjacent to the microfluidic channel is substantially perpendicular to the microfluidic channel. For example, FIG. 4B shows the ring electrode 404 having a first portion (including high sensitivity region 406) that is substantially perpendicular to the fluidic channel 304.

(A7) In some embodiments of A1-A6, at least a portion of the sensor is parallel to a portion of the transmission line. For example, FIG. 4B shows the ring electrode 404 having a first portion (including high sensitivity region 406) that is substantially parallel to the transmission line 402.

(A8) In some embodiments of A1-A7, the method 700 further includes (722) generating radiofrequency (RF) signals at two or more frequencies using first circuitry (e.g., using the driver circuitry 412).

(A9) In some embodiments of A1-A8, the method 700 further includes (724) sequentially detecting an electrical signal (e.g., a voltage or current) from the sensor electrode at two or more frequencies (e.g., the two or more frequencies at which the RF signals are generated using the first circuitry) using second circuitry (e.g., using the readout circuitry 414).

(A10) In some embodiments of A9, the method 700 further includes (726) utilizing the detected electrical signal to determine one or more characteristics (e.g., sub-cellular or molecular properties) of the plurality of particles. In some embodiments, determining the one or more characteristics of the plurality of particles includes aggregating the characteristics of each individual particle.

(A11) In some embodiments of A10, the device is in an array with a second device, and the method 700 further includes adjusting (728) an input signal to a second device based on the determined one or more characteristics.

(A12) In some embodiments of A1-A11, the method 700 further includes, after detecting the plurality of particles, aspirating (740) the plurality of particles via an opening adjacent to the microfluidic channel (e.g., the opening 506).

(A13) In some embodiments of A1-A12, the method 700 further includes, after detecting the plurality of particles, dispensing (750) the plurality of particles via an opening adjacent to the microfluidic channel (e.g., the opening 506).

(A14) In some embodiments of A1-A13, the sensor is, or includes, at least one of: a parallel plate electrode, an optical ring resonator, or a double optical ring resonator.

In accordance with some embodiments, an electrode system having one or more devices (e.g., the devices 300-1 and 300-2) is configured to perform any of the methods described herein (e.g., methods described with respect to embodiments A1-A14 above).

(B1) In some embodiments, a microfluidic device (e.g., the device 300) includes: a sensor (e.g., the ring electrode 404) positioned adjacent to a microfluidic channel (e.g., the fluidic channel 304) for detecting particles (e.g., the cell 410) flowing through the microfluidic channel; and a transmission line (e.g., the transmission line 402) positioned adjacent to the sensor for receiving electromagnetic signals from the sensor.

(B2) In some embodiments of B1, the microfluidic device further includes a substrate (e.g., the substrate 502) having the microfluidic channel.

(B3) In some embodiments of B1 or B2, sensor is, or includes, a sensor electrode. In some embodiments, the sensor includes at least one of: a parallel plate electrode, an optical ring resonator, a double optical ring resonator, a ring electrode, a closed cavity resonator, or a strip-line resonator.

(B4) In some embodiments of B1-B3, the sensor electrode defines a substantially enclosed loop with a gap (e.g., the gap at the high sensitivity region 406).

(B5) In some embodiments of B4, the gap is positioned adjacent to the microfluidic channel. For example, the gap at the high sensitivity region 406 is adjacent to the convergent portion of the fluidic channel 304 in FIG. 4B.

(B6) In some embodiments of B4 or B5, the gap is positioned above or below the microfluidic channel (e.g., as shown in FIG. 4B).

(B7) In some embodiments of B1-B6, the sensor electrode substantially has a shape of a rectangle with a gap (e.g., as shown in FIG. 4A).

(B8) In some embodiments of B1-B7, the transmission line is substantially perpendicular to (a projection of) the microfluidic channel (e.g., as shown in FIG. 4B).

(B9) In some embodiments of B1-B8, at least a portion of the sensor electrode adjacent to the microfluidic channel is substantially perpendicular to (a projection of) the microfluidic channel. For example, FIG. 4B shows the ring electrode 404 having a first portion (including high sensitivity region 406) that is substantially perpendicular to the fluidic channel 304.

(B10) In some embodiments of B1-B9, at least a portion of the sensor electrode is parallel to a portion of the transmission line. For example, FIG. 4B shows the ring electrode 404 having a first portion (including high sensitivity region 406) that is substantially parallel to the transmission line 402.

(B11) In some embodiments of B1-B10, the device further includes first circuitry for sequentially providing radiofrequency signals at two or more frequencies (e.g., the driver circuitry described above with reference to FIG. 4B).

(B12) In some embodiments of B1-B10, the device further includes second circuitry for sequentially detecting a voltage or current across the sensor electrode at two or more frequencies (e.g., the readout circuitry described above with reference to FIG. 4B).

(B13) In some embodiments of B12, the second circuitry is further configured to determine one or more characteristics (e.g., sub-cellular or molecular properties) of the plurality of particles based on the detected voltages or currents.

(B14) In some embodiments of B1-B13, the device further includes an opening adjacent to the microfluidic channel for aspirating and/or dispensing the plurality of particles (e.g., the opening described above with reference to FIG. 4B).

(B15) In some embodiments of B1-B14, the microfluidic channel includes a bypass duct (e.g., bypass duct 422) for adjusting a rate of flow of particles past the sensor.

(B16) In some embodiments of B15, the bypass duct is positioned upstream on the microfluidic channel from the sensor. For example, FIG. 4D shows the bypass duct positioned upstream from the region 406.

(B17) In some embodiments of B15 or B16, the device further includes a piezoelectric deflector (e.g., the deflector 420) positioned adjacent to the bypass duct and operable to deflect particles in the microfluidic channel into the bypass duct.

It will be understood that, although the terms first, second, etc. may be used herein to describe various elements, these elements should not be limited by these terms. These terms are only used to distinguish one element from another. For example, a first sensor could be termed a second sensor, and, similarly, a second sensor could be termed a first sensor, without departing from the scope of the various described embodiments. The first sensor and the second sensor are both sensors, but they are not the same sensor.

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

What is claimed is:

1. A microfluidic device, comprising:
a sensor positioned adjacent to a microfluidic channel for detecting particles flowing through the microfluidic channel; and
a transmission line positioned adjacent to the sensor for receiving electromagnetic signals from the sensor.

2. The microfluidic device of claim 1, further comprising:
a substrate with the microfluidic channel.

3. The microfluidic device of claim 1, wherein:
the sensor includes a parallel plate electrode.

4. The microfluidic device of claim 1, wherein:
the sensor includes an optical ring resonator.

5. The microfluidic device of claim 1, wherein:
the sensor includes a double optical ring resonator.

6. The microfluidic device of claim 1, wherein:
the sensor comprises a sensor electrode.

7. The microfluidic device of claim 6, wherein:
the sensor electrode defines a substantially enclosed loop with a gap.

8. The microfluidic device of claim 7, wherein:
the gap is positioned adjacent to the microfluidic channel.

9. The microfluidic device of claim 7, wherein:
the gap is positioned above or below the microfluidic channel.

10. The microfluidic device of claim 7, wherein:
the sensor electrode substantially has a shape of a rectangle with a gap.

11. The microfluidic device of claim 1, wherein:
the transmission line is substantially perpendicular to the microfluidic channel.

12. The microfluidic device of claim 1, wherein:
at least a portion of the sensor adjacent to the microfluidic channel is substantially perpendicular to the microfluidic channel.

13. The microfluidic device of claim 12, wherein:
at least a portion of the sensor is parallel to a portion of the transmission line.

14. The microfluidic device of claim 1, wherein:
the microfluidic channel includes a bypass duct for adjusting a rate of flow of particles past the sensor.

15. The microfluidic device of claim 14, wherein:
the bypass duct is positioned upstream on the microfluidic channel from the sensor.

16. The microfluidic device of claim 14, further comprising:
a piezoelectric deflector positioned adjacent to the bypass duct and operable to deflect particles in the microfluidic channel into the bypass duct.

17. The microfluidic device of claim 1, further comprising:
first circuitry for sequentially providing radiofrequency signals at two or more frequencies.

18. The microfluidic device of claim 17, further comprising:
second circuitry for sequentially detecting a voltage or current across the sensor electrode at the two or more frequencies.

19. A method, comprising:
providing a plurality of particles through a microfluidic channel;
detecting the plurality of particles flowing through the microfluidic channel with a sensor positioned adjacent to the microfluidic channel; and
transmitting electrical signals with a transmission line positioned adjacent to the sensor.

20. The method of claim 19, wherein detecting the plurality of particles comprises using a substantially enclosed loop sensor electrode with a gap.
